(19) United States
(12) Patent Application Publication
(10) Pub. No.: US 2011/0024207 A1
(43) Pub. Date: Feb. 3, 2011

(54) BATTERY PACK AND METHOD OF PRODUCING THE BATTERY PACK

(75) Inventors: Tatsuya Higashino, Kanagawa (JP); Kazuo Saito, Kanagawa (JP); Toshiyuki Motohashi, Saitama (JP)

Correspondence Address: FOLEY AND LARDNER LLP;SUITE 500, 3000 K STREET NW, WASHINGTON, DC, 20007, US

(73) Assignees: NISSAN MOTOR CO., LTD., Yokohama-shi, Kanagawa (JP); CALSONIC KANSEI CORPORATION, Saitama-shi, Saitama (JP)

(21) Appl. No.: 12/937,298

(22) PCT Filed: Apr. 8, 2009
(86) PCT No.: PCT/JP2009/001627

§ 371 Date: Oct. 11, 2010

(30) Foreign Application Priority Data
Apr. 14, 2008 (JP) 2008-104682
Mar. 2, 2009 (JP) 2009-048211

(51) Int. Cl. B60L 11/18; H01M 10/02; H01M 10/52; H01M 10/38

(52) U.S. Cl. 180/65.1; 429/156; 429/151; 429/53; 29/623.1

(57) ABSTRACT

A battery pack comprises a battery stack. The battery stack includes a plurality of battery modules that are arranged in parallel in side-by-side relationship; a plurality of couplers each being mounted on a given portion of the corresponding battery module thereby to constitute a coupler-mounted battery module. The couplers are detachably connected to one another to constitute an aligned unit of the couplers. Each of the couplers comprises a plurality of projected pawls provided by one side of the coupler and a plurality of catching recesses provided by the other side of the coupler. The catching recesses catch the projected pawls of an adjacent coupler for forming part of the aligned unit of the couplers.

### TECHNICAL FIELD

The present invention relates to a battery pack and a method of producing the battery pack.

### BACKGROUND ART

A battery pack used as a power supply means for driving a vehicle, such as electric road vehicle, electric railcar or the like, is formed of a plurality of battery modules which are arranged in parallel, each battery module consisting of a plurality of cells connected in series and installed in a case.

For tightly joining the battery modules together, various measures have been hitherto proposed and put into practical use. One of them is shown in Japanese Laid-open Patent Application (tokkai) 2005-5167.

In the measure of the Laid-open Application, a plurality of elongate flat holders are prepared each carrying or holding a plurality of battery modules. Each elongate flat holder is formed at given portions thereof with a plurality of through openings. To constitute a battery pack (or battery stack), these elongate flat holders neatly put on one another in such a manner that corresponding through openings of the elongate flat holders are aligned and mated and a plurality of connecting bars are threaded through the mated through openings to bind or combine the elongate flat holders together.

### DISCLOSURE OF INVENTION

### Technical Problem

However, in the measure of the above-mentioned Laid-open Application, using a plurality of connecting bars and threading the connecting bars through the mated through openings for binding or combining the elongate flat holders tends to bring about increase in assembling steps, which thus causes increase in production cost of the battery pack. That is, in the known measure, workability of joining the elongate flat holders is somewhat poor.

### Solution to Problem

It is therefore an object of the present invention to provide a battery pack and a method of producing the battery pack, which solve the above-mentioned drawbacks.

More specifically, an object of the present invention is to provide a low-cost and reliable battery pack, a method of easily and speedily assembling the battery back.

In the present invention, when one coupler-mounted battery module is properly arranged beside another coupler-mounted battery module and pressed against the same, not only coupling but also positioning between these two battery modules are carried out simultaneously.

In accordance with a first aspect of the present invention, there is provided a battery pack which comprises a battery stack that includes a plurality of battery modules that are arranged in parallel in side-by-side relationship; a plurality of couplers each being mounted on a given portion of the corresponding battery module thereby to constitute a coupler-mounted battery module, the couplers being detachably connected to one another to constitute an aligned unit of the couplers, wherein each of the couplers comprises a plurality of projected pawls provided by one side of the coupler; and a plurality of catching recesses provided by the other side of the coupler, the catching recesses catching the projected pawls of an adjacent coupler for constituting part of the aligned unit of the couplers.

In accordance with a second aspect of the present invention, there is provided a battery pack which comprises a battery stack that includes a plurality of battery modules that are arranged in parallel in side-by-side relationship; a first group of couplers each being mounted on a first given portion of the corresponding battery module, the first group of couplers being detachably connected to one another to constitute a first aligned unit of the first group of couplers; and a second group of couplers each being mounted on a second given portion of the corresponding battery module, the second group of couplers being detachably connected to one another to constitute a second aligned unit of the second group of couplers, wherein each of the couplers of the first and second groups comprises a plurality of projected pawls provided by one side of the coupler; and a plurality of catching recesses provided by the other side of the coupler, the catching recesses catching the projected pawls of an adjacent coupler for producing part of the first or second aligned unit.

In accordance with a third aspect of the present invention, there is provided a method of producing a battery pack. The battery pack comprises a battery stack that a plurality of battery modules that are arranged in parallel in side-by-side relationship; a plurality of couplers each being mounted on a given portion of the corresponding battery module thereby to constitute a coupler-mounted battery module, the couplers being detachably connected to one another to constitute an aligned unit of the couplers, wherein each of the couplers comprises a plurality of projected pawls provided by one side of the coupler; and a plurality of catching recesses provided by the other side of the coupler, the catching recesses catching the projected pawls of an adjacent coupler for constituting part of the aligned unit of the couplers. The method comprises in steps (a) preparing a plurality of coupler-mounted battery modules each including a battery module and a coupler mounted on a given portion of the battery module; (b) putting a first one of the coupler-mounted battery modules at a first given position; (c) putting a second one of the coupler-mounted battery modules at a position beside the first one of the coupler-mounted battery modules; (d) pressing the second one of the coupler-mounted battery modules against the first one of the coupler-mounted battery module to achieve a connection between the projected pawls of the second one of the coupler-mounted battery modules and the catching recesses of the first one of the coupler-mounted battery modules; and (e) repeating the same operation as the steps (b), (c) and (d) one after another on the remaining coupler-mounted battery modules.

### BRIEF DESCRIPTION OF DRAWINGS

FIG. 1 is a perspective view of a battery pack of a first embodiment of the present invention.

FIG. 2 is a schematic side view of a wheeled vehicle to which the battery back of the invention is practically applied.

FIG. 3 is a perspective view of a battery stack that constitutes an essential element of the battery pack of FIG. 1.

FIG. 4 is a perspective view of one of identical battery modules installed in the battery stack of FIG. 3.

FIG. 5 is a perspective view of one of identical cells (or secondary batteries) that constitute the battery module.

FIG. 6 is a perspective view of one of identical couplers (or frame members), that is to be mounted on one axial end of a corresponding battery module.

FIG. 7 is an exploded view of two identical couplers and one battery module that, when assembled, constitute a coupler-mounted battery module shown in a bottom part of the drawing.

FIG. 8 is an enlarged perspective view of a coupling portion of the coupler of FIG. 6, that is viewed from the direction of VIII in FIG. 6.

FIG. 9 is a perspective view of a portion of the battery stack of FIG. 3 where two couplers are joined at the coupling portions.

FIG. 10 is a view similar to FIG. 3, but showing schematically a path through which cooling air flows.

FIG. 11 is an enlarged perspective view of a portion of the battery pack, showing the path of the cooling air.

FIG. 12 is a perspective view of a lower stack frame that is assembled to support the battery stack of FIG. 3.

FIG. 13 is a view similar to FIG. 12, but showing two coupler-mounted battery modules set on the lower stack frame.

FIG. 14 is an enlarged view of a lower portion of the battery pack of FIG. 13 where a part of the cooling air passages is formed.

FIG. 15 is a view similar to FIG. 13, but showing a plurality of coupler-mounted battery modules set on the lower stack frame.

FIG. 16 is a view similar to FIG. 15, but showing an upper stack frame that is mounted on the coupler-mounted battery modules.

FIG. 17 is an enlarged view of an upper portion of the battery pack of FIG. 16 where another part of the cooling air passages is formed.

FIG. 18 is a view similar to FIG. 16, but showing a rear end plate that is arranged at a rear end of the stack of the coupler-mounted battery modules.

FIG. 19 is a view similar to FIG. 6, but showing a modified coupler that is employable in the battery pack of the first embodiment.

FIG. 20 is a perspective view of a battery stack that constitutes an essential element of a battery pack of a second embodiment of the present invention.

FIG. 21 is a perspective view of one of identical battery modules installed in the battery pack of FIG. 20.

FIG. 22 is a perspective view of one of identical couplers (or frame members), that is to be mounted on one axial end of a corresponding battery module employed in the battery pack of the second embodiment.

FIG. 23 is a view similar to FIG. 22, but showing a back portion of the coupler.

FIG. 24 is an enlarged sectional view of a portion of the battery stack of FIG. 20, where a pipe portion of one coupler is properly engaged with a cylindrical bore of an adjacent coupler to constitute part of a gas discharging piping unit.

FIG. 25 is an enlarged perspective view of a portion of the battery stack of FIG. 20, where part of the gas discharging piping unit is provided.

### REFERENCE TO SIGNS LIST

10 Vehicle
20 Battery pack
22 Air inlet opening
24 Air outlet opening
26 Housing
30 Battery stack
40 Battery module
41 Output terminal
42 Rectangular case
44 Lower case part
46 Upper case part
48 Dimple
49 Dimple
50 Cell
54 Positive flat electrode tab
56 Negative flat electrode tab
58 Charging/generative zone
60 Coupler
60′ Modified coupler
61 Coupler
70 Rib portion
72 Pin portion
74 Pole portion
78 Pad portion
79 Pad portion
80 Corner holding portion
82 Projected pawl
84 Catching recess
86 Guide portion
88 Pad portion
90 Lower stack frame
92 Upper stack frame
94 Front end plate
96 Rear end plate
130 Battery stack
132 Gas discharging piping unit
133 Gas discharging piping unit
135 Main pipe
136 Pipe connector
137 Pipe connector
138 Gas outlet nozzle
140 Battery module
141 Output terminal
142 Rectangular case
144 Lower case part
145A Gas outlet opening
145B Gas outlet opening
146 Upper case part
160 Coupler
161 Coupler
164 Lower pipe
165 O-ring
166 Cube portion
167 Cylindrical bore
168 Pipe portion
169 O-ring
170 Rib portion
178 Elongate pad portion
179 Semicircular pad portion
180 Corner holding portion
181 Projected pawl
184 Catching recess
186 Guide portion
188 Pad portion

### BEST MODE FOR CARRYING OUT THE INVENTION

In the following, embodiments of the present invention will be described in detail with reference to the accompanying drawings.

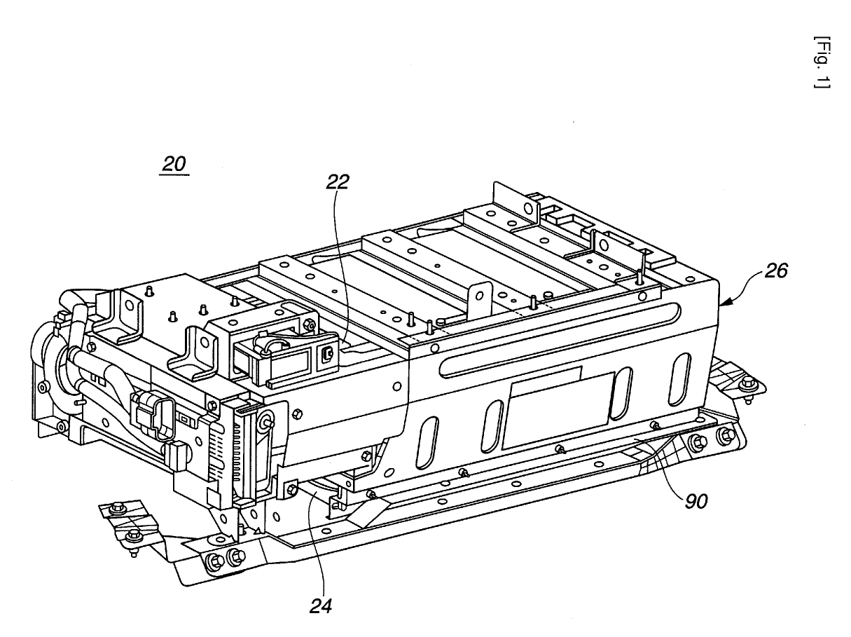

Referring to FIG. 1, there is shown a battery pack 20 which is a first embodiment of the present invention.

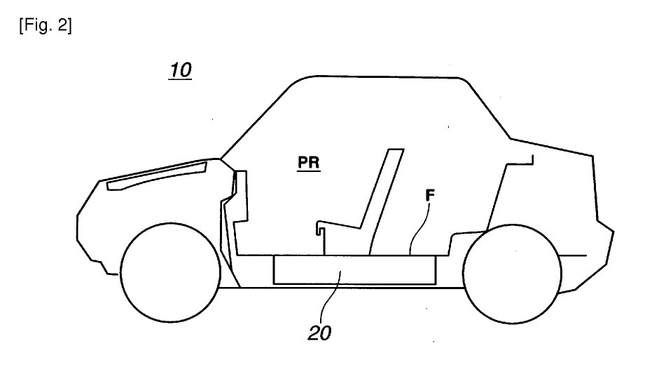

As is seen from FIG. 2, such battery pack 20 is installed below a floor F of a passenger room PR of a vehicle 10, such as an electric road vehicle, hybrid motor vehicle, electric railcar, fuel-cell vehicle or the like. Battery pack 20 is used as a power source means for fully powering or partially powering the vehicle 10.

In the illustrated example, battery pack 20 is set below passenger seats at a generally middle position of the vehicle 10. However, in place of the position below the passenger seats, other positions of the vehicle, such as, a rear trunk room, front engine room, rear luggage space, center console and the like may be used for placing battery pack 20.

As will become apparent as the description proceeds, due to a low-cost and high reliable construction of battery pack 20, a vehicle that has the battery pack 20 mounted thereon enjoys such low-cost and high reliable performance.

Furthermore, since battery pack 20 is made small in size and high in performance, the vehicle to which battery pack 20 is practically mounted may be of a type that has only a small space for mounting the battery pack.

Referring back to FIG. 1, denoted by numeral 22 is an air inlet opening of battery pack 20, that is adapted to connect to an air inlet duct (not shown) for receiving cooling air into a cooling air passage formed in battery pack 20. While, denoted by numeral 24 is an air outlet opening of battery pack 20, that is adapted to connect an air outlet duct (not shown) for discharging the cooling air from the cooling air passage to the outside.

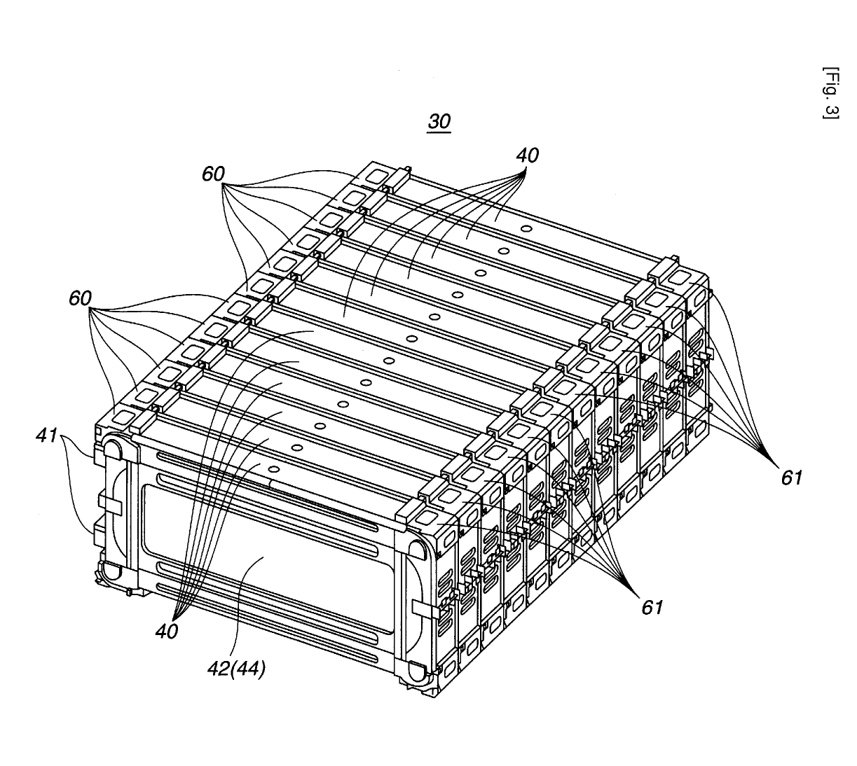

FIG. 3 shows a battery stack 30 that is installed in battery pack 20. As shown, battery stack 30 comprises a plurality of battery modules 40 stacked in a given direction, each battery module 40 being rectangular in shape and equipped with two couplers 60 and 61. As will be described in detail hereinafter, these couplers 60 and 61 are the same in construction and constitute a frame structure.

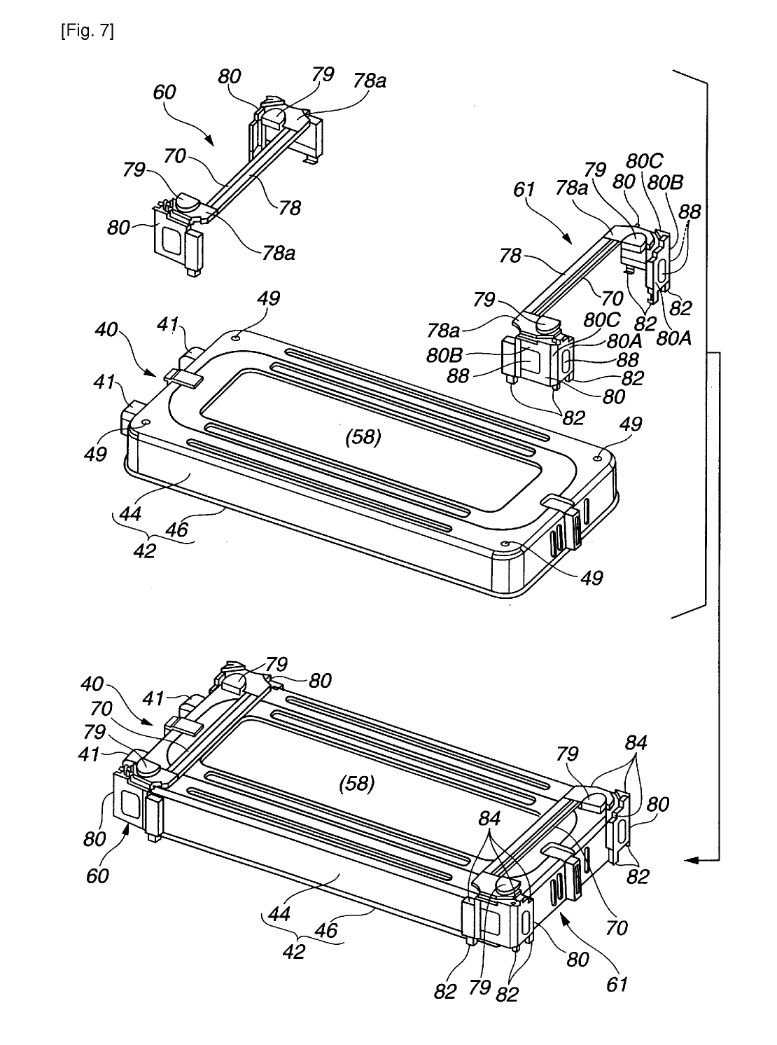

These identical couplers 60 and 61 are molded from plastics, such as polypropylene or the like, and these couplers 60 and 61 are put on axially opposed ends of battery module 40, as may be understood from FIG. 7.

FIG. 7 shows the two identical couplers 60 and 61 which are arranged to face each other. In use, these two identical couplers 60 and 61 are respectively put on axially opposed ends of battery module 40.

For ease of description, the battery module 40 having the two identical couplers 60 and 61 mounted thereon will be called “coupler-mounted battery module” in the following.

As will be described in detail hereinafter, when a plurality of coupler-mounted battery modules 40 are properly stacked to constitute battery stack 30 and the battery stack 30 is installed in a housing 26 to constitute battery pack 20, there are defined a plurality of air passages in the battery pack 20, which are an air intake passage that is defined between a ceiling wall of the housing 26 and an upper side of the battery stack 30, a plurality of fine passages each being defined between two adjacent battery modules 40 and an air discharge passage that is defined between a bottom wall of the housing 26 and a lower side of the battery stack 30.

That is, when the battery pack 20 is practically used, cooling air is forced to flow from the air intake passage toward the air discharge passage through the fine passages. Wish such cooling air flow, battery modules 40 are suitably cooled.

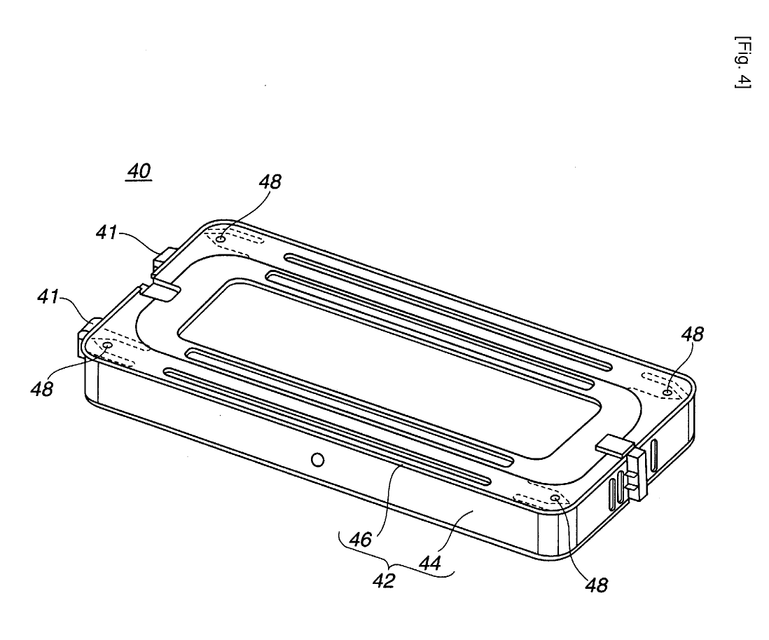

As is seen from FIG. 4, each battery module 40 is equipped with output terminals 41 and 41.

As is seen from FIG. 4, each battery module 40 comprises a rectangular case 42 that includes a lower case part 44 shaped like a

rectangular pan and an upper case part 46 shaped like a flat rectangular lid. Four corners of upper case part 46 are fixed to corresponding four corners of lower case part 44 by means of caulking.

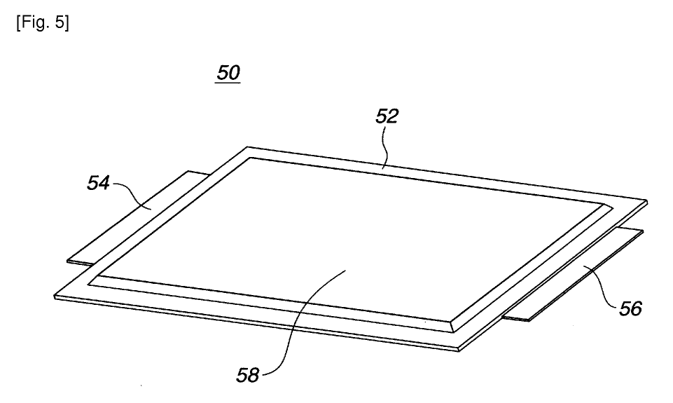

Within the case 42, there are intimately installed a plurality of cells 50 (or secondary batteries, see FIG. 5) connected in series. The number of battery modules 40 for the battery stack 30 (see FIG. 3) is selected in view of output characteristics needed by battery pack 20.

Referring back to FIG. 4, lower case part 44 and upper case part 46 are each constructed of a thin steel plate or aluminum plate. By using such materials, after-mentioned cooling performance and temperature controllability of battery pack 20 are improved.

Within rectangular case 42, there are arranged the cells 50 (see FIG. 5) and four sleeves (not shown). The four sleeves are put at the four corners of case 42 to serve as reinforcing members of the case 42. Due to provision of such reinforcing members (viz., four sleeves), each battery module 40 exhibits a sufficient strength against a clamping force applied to battery stack 30.

As is seen from FIG. 4, upper case part 46 is formed at four corner portions with dimples 48, and as is seen from FIG. 7, lower case part 44 is formed at its outside four corner portions with dimples 49. These dimples 48 and 49 are used as positioning means when the two identical couplers 60 and 61 are mounted to the case 42. If desired, such dimples 48 and 49 may be replaced by circular through openings formed in the corresponding portions.

As is understood from FIG. 5, each cell 50 (or secondary battery) is a flat type lithium-ion battery that is formed by accommodating electromotive elements consisting of laminated positive and negative electrode plates with separators interposed therebetween. As shown, cell 50 is hermetically sealed in a flat packaging member 52 made of a laminated film or the like. Cell 50 has positive and negative flat electrode tabs 54 and 56 exposed from packaging member 52. A charging/generating zone of cell 50 is indicated by numeral 58. Charging/generating zones 58 of the outermost two cells 50 in the case (see FIG. 4) are in contact with respective inner surfaces of lower case part 44 and upper case part 46.

As is known, lithium-ion battery is compact and high-powered battery, and thus, the battery pack 20 can be made compact in size, and thus the battery pack 20 is suitable for the power source of a vehicle that needs a high power.

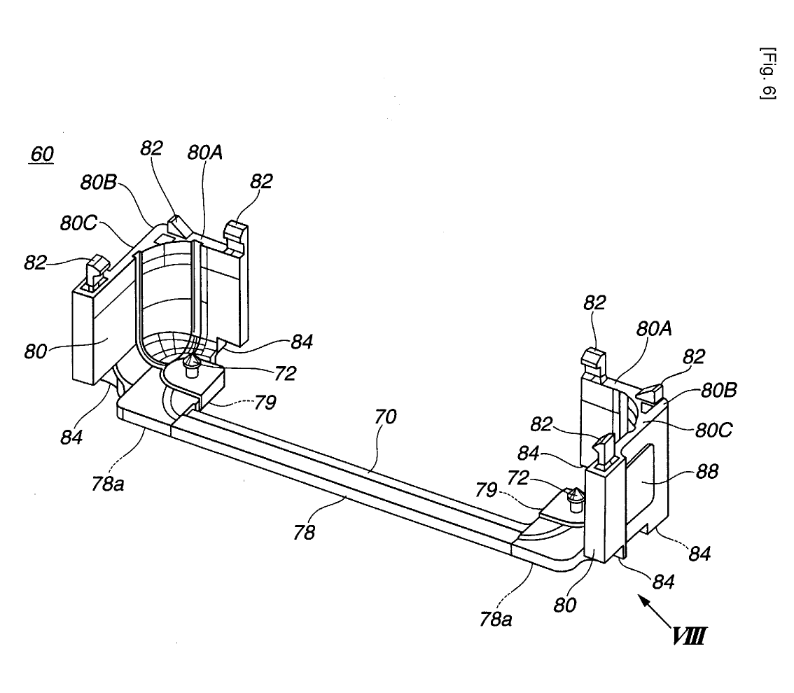

In the following, the two couplers 60 and 61 will be described in detail with reference to the drawings, particularly FIG. 6.

As has been mentioned hereinabove and as is seen from FIG. 7, the two couplers 60 and 61 are the same in construction. Thus, in the following, the description will be directed to only one coupler 60 for ease of description.

As is shown in FIG. 6, coupler 60 generally comprises a rib portion 70 and two corner holding portions 80 formed on axially opposed ends of rib portion 70.

As is seen from FIG. 7, coupler 60 is mounted on a left side (when viewed in the drawing) of the bottom wall of lower case part 44 of the case 42 in such a manner that rib portion 70 extends on the bottom wall in a direction perpendicular to a longitudinal axis of the rectangular case 42. More specifically, rib portion 70 extends on the bottom wall of lower case part 44 in parallel with an imaginary line that passes through the two output terminals 41 and 41 of battery module 40.

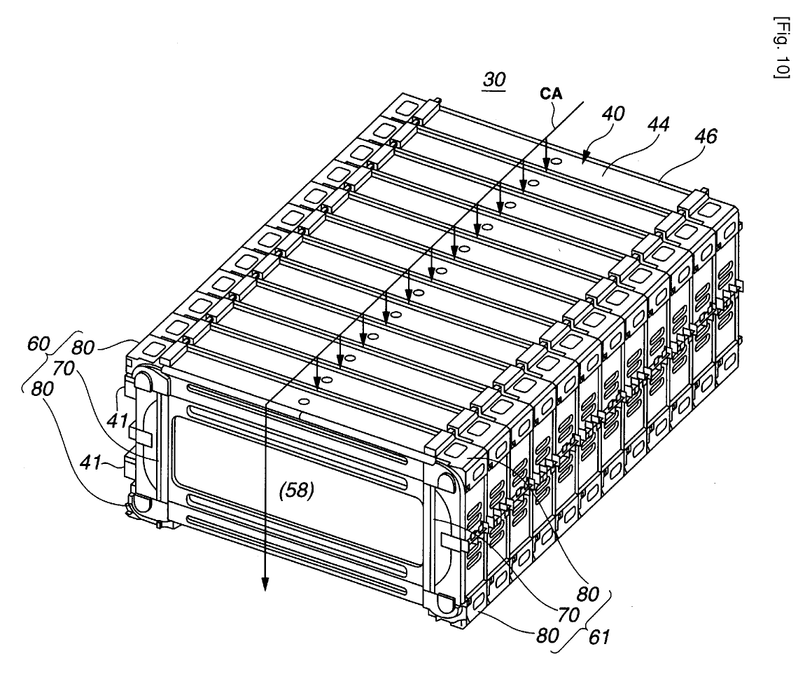

It is however to be noted that rib portion 70 is positioned away from a portion of the case 42 that faces the charging/generating zone 58 of the outermost cell 50. This arrangement may be easily understood from FIG. 10.

Accordingly, when a coupler-mounted battery module 40 is properly joined with an adjacent coupler-mounted battery module 40, the rib portion 70 is put between the two battery modules 40 in a manner to define a fine clearance therebetween. More specifically, rib portion 70 is put between the bottom wall of lower case part 44 of the coupler-mounted battery module 40 and the upper case part 46 of the other battery module 40 that has just put on the coupler-mounted battery module 40.

As is seen from FIGS. 6 and 7, rib portion 70 has two pin portions 72 that are provided at longitudinally opposed ends of rib portion 70 and raised (in FIG. 6) from an inside surface of rib portion 70 that contacts the bottom wall of lower case part 44, two flat semicircular pad portions 79 that are formed at vertically opposed sides of the pin portions 72 (see FIG. 7) and an elongate pad portion 78 (see FIG. 7) that extends between two flat corner portions 78a on which the flat semicircular pad portions 79 are provided.

In FIG. 7, battery module 40 is shown with its lower case part 44 raised upward. That is, upper case part 46 is shown to be placed at a lower side. When coupler 60 (or 61) is properly mounted on the battery module 40 as shown in FIG. 7, elongate pad portion 78 contacts the bottom wall of lower case part 44, and the pad portions 79 face upward as shown.

At the same time, two pin portions 72 (which are hidden in FIG. 7) of coupler 60 are mated with two dimples 49 formed at the two corners of the bottom wall of lower case part 44, and two pin portions 72 (which are also hidden in FIG. 7) of the other coupler 61 are mated with two dimples 49 formed at other two corners of the bottom wall of lower case part 44.

Due to provision of such pin portions 72 and dimples 49, positioning of two couplers 60 and 61 relative to battery module 40 is easily and speedily carried out, which facilitates exact and proper setting of the two couplers 60 and 61 onto the battery module 40.

As will be understood from FIG. 7, when another coupler-mounted battery module 40 (not shown) is properly joined with the coupler-mounted battery module 40, the four pad portions 79 of the two couplers 60 and 61 suitably support the upper case part 46 of the other battery module 40.

It is to be noted that when the two couplers 60 and 61 are put between the two coupler-mounted battery modules 40 in the above-mentioned manner, the resilient construction of each rib portion 70, more specifically, the resilient construction including flat semicircular pad portions 79 and elongate pad portion 78 of each rib portion 70, serves as a shock absorber thereby to stably hold the two battery modules 40 without inducing displacement therebetween.

As is seen from FIG. 7, corner holding portions 80 formed on the axially opposed ends of rib portion 70 of each coupler 60 or 61 are shaped to hold or cover the corner portions of lower case part 44.

That is, as is seen from FIG. 6, corner holding portion 80 comprises a shorter side wall portion 80A that partially covers a shorter side of lower case part 44, a longer side wall portion 80C that partially covers a longer side of lower case part 44 and a rounded middle wall portion 80B through which the two side wall portions 80A and 80C are connected. As is seen, shorter and longer side wall portions 80A and 80C make a right angle therebetween. The arrangement of such wall portions 80A, 80C and 80B relative to lower case part 44 of battery module 40 will be well understood from FIG. 7.

As is understood from FIGS. 6 to 10, each corner holding portion 80 is formed with a coupling structure that is constructed to join the associated battery module 40 to two adjacent battery modules 40 between which the associated battery module 40 is put.

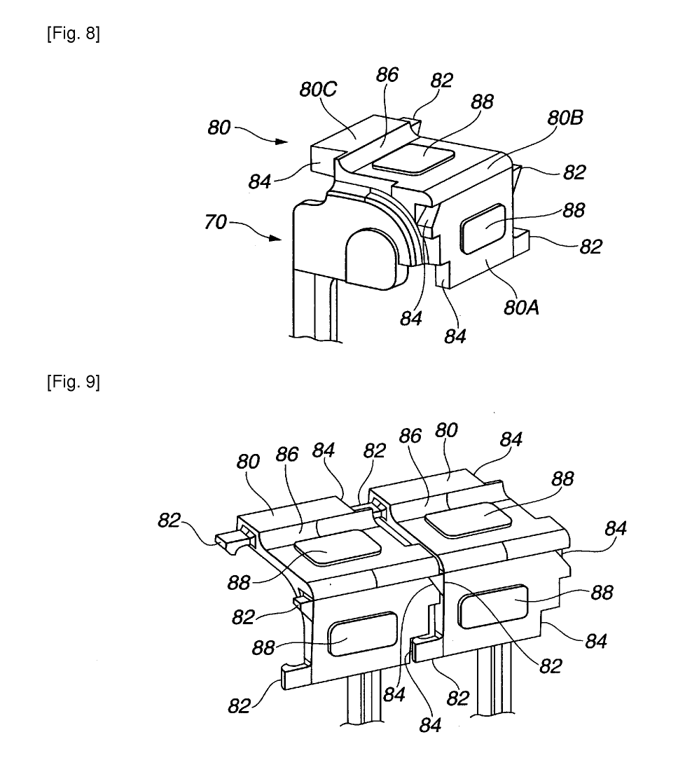

As is best seen from FIG. 8, the coupling structure generally comprises three projected pawls 82, three catching recesses 84, a guide portion 86 and two pad portions 88.

The three projected pawls 82 are provided on one side of the corner holding portion 80 and the three catching recesses 84 are provided on the other side of the corner holding portion 80, and the guide portion 86 and the two pad portions 88 are formed on a middle portion of the corner holding portion 80.

More specifically, as is seen from FIG. 7, when coupler 60 or 61 is properly mounted on battery module 40, the three projected pawls 82 of each corner holding portion 80 are placed at one corner of upper case part 46 of battery module 40 projecting downward (as viewed in the drawing), and at the same time, the three catching recesses 84 of each corner holding portion 80 are placed at a corresponding corner of the bottom of lower case part 44 of battery module 40 facing upward (as viewed in the drawing).

As is seen from FIG. 7, these three projected pawls 82 are formed on lower ends of the shorter side wall portions 80A and 80C. As shown, shorter and longer side wall portions 80A and 80C are connected through a curved part 80B to constitute a generally L-shaped structure.

More specifically, as is clearly shown in FIG. 8, these three projected pawl 82 are formed on an end of the shorter side wall portion 80A, an end of the curved part 80B and an end of the longer side wall portion 80C, respectively.

As will be understood from FIGS. 8 and 9, three catching recesses 84 of each coupling structure are constructed to detachably catch corresponding projected pawls 82 of a coupling structure of an adjacent coupler 60 or 61. For this reason, three catching recesses 84 and three projected pawls 82 are formed opposed ends of each coupling structure, respectively.

Accordingly, as is understood from FIGS. 7 and 9, when two coupler-mounted battery modules 40 and 40 are properly put on each other, six projected pawls 82 in total of each coupler 60 or 61 of one of the modules 40 are brought into engagement with six catching recesses 84 in total of the coupler 60 or 61 of the other one of the modules 40 to constitute a so-called double deck battery pack. When another coupler-mounted battery module 40 is properly put on one side of the double deck battery pack, a so-called three deck battery pack is produced.

It is to be noted that, in the present invention, a plurality (at least two) of projected pawls 82 and a plurality (at least two) of catching recesses 84 are employed for joining adjacent coupler-mounted battery modules 40. That is, coupling the two (or more) coupler-mounted battery modules 40 simultaneously brings about an assured positioning of one coupler-mounted battery module 40 relative to the other one 40. In other words, when one coupler-mounted battery module 40 is pressed against the other one 40, both coupling and positioning between the two coupler-mounted battery modules 40 are simultaneously carried out.

Due to usage of such at least two projected pawls 82 and at least two catching recesses 84, undesired relative rotary motion between the two coupler-mounted battery modules 40 is suppressed.

If desired, the number of projected pawls 82 and that of the catching recesses 84 may change in accordance with a magnitude of connecting power that is needed between the stacked coupler-mounted battery modules 40.

As is seen from FIGS. 8 and 9, guide portion 86 of the coupling structure has a rounded outer surface and extends along a direction in which the coupler-mounted battery modules 40 are stacked. As will be described hereinafter, such guide portions 86 are used for smoothly guiding the couplers 60 and 61 to proper positions of stack frames to which battery stack 30 is connected.

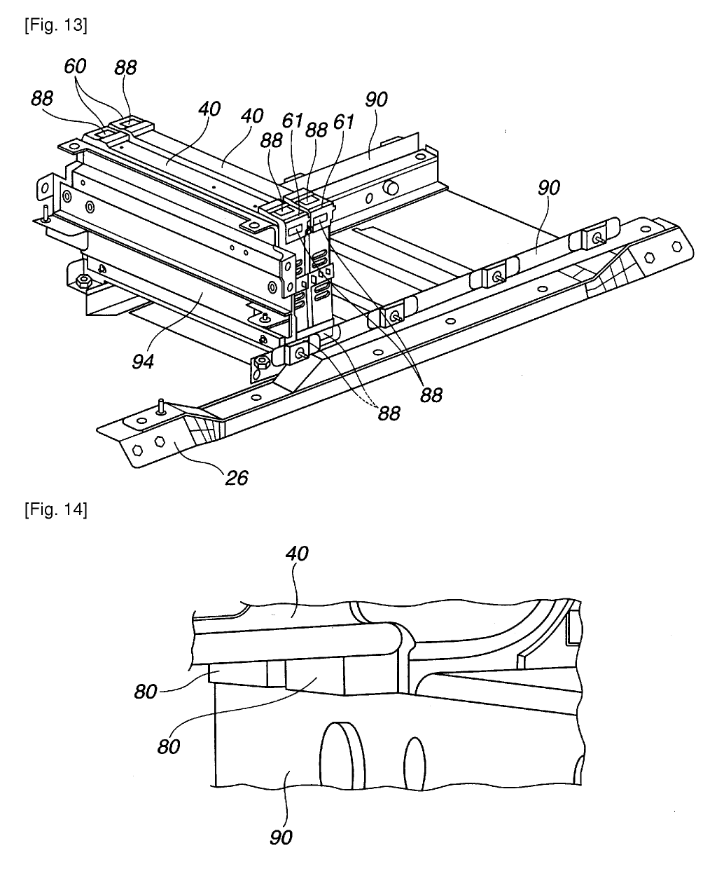

That is, as is seen from FIG. 13, when it is needed to put a second coupler-mounted battery module 40 beside a previously set first coupler-mounted battery module 40, guide portion 86 of the coupler 60 (or 61) of the second coupler-mounted battery module 40 is brought into contact with the stack frame 90 and then the second coupler-mounted battery module 40 is slid along the stack frame 90 to a position where the projected pawls 82 of the second coupler-mounted battery module 40 are engaged with the catching recesses 84 of the first coupler-mounted battery module 40. Due to provision of such guide portion 86, the work for properly stacking the coupler-mounted battery modules 40 is easily and speedily carried out.

As is seen from FIGS. 8 and 9, two pad portions 88 of the coupling structure are provided on the shorter side wall portion 80A and longer side wall portion 80C respectively. Each pad portion 88 is made of a shock absorbing material. As will be described hereinafter, these pad portions 88 are in contact with stack frames of a housing 26.

Due to provision of such pad portions 88, any shock or vibration applied to each battery module 40 through the stack frames of the housing is absorbed or at least attenuated.

If desired, the above-mentioned elongate pad portion 78 (see FIG. 7), semicircular pad portions 79 and pad portions 88 may be integrally molded together with the major portion of coupler 60 or 61. Or, if desired, such portions 78, 79 and 88 may be separate members that are bonded to corresponding portions of the major portion of coupler 60 or 61.

Referring to FIG. 10, there is shown the battery stack 30 that comprises a plurality of coupler-mounted battery modules 40 that are stacked in the above-mentioned manner. This drawing is provided for explaining a cooling air passage provided in the battery stack 30.

When a plurality of coupler-mounted battery modules 40 are stacked in the above-mentioned manner, rib portions 70 of couplers 60 and 61 of each battery module 40 are put between two adjacent coupler-mounted battery modules 40, that is, between the bottom wall of lower case part 44 of one battery module 40 and the upper case part 46 of the other battery module 40. Accordingly, a certain space is defined between the two adjacent coupler-mounted battery modules 40, which constitutes an after-mentioned fine passage for cooling air.

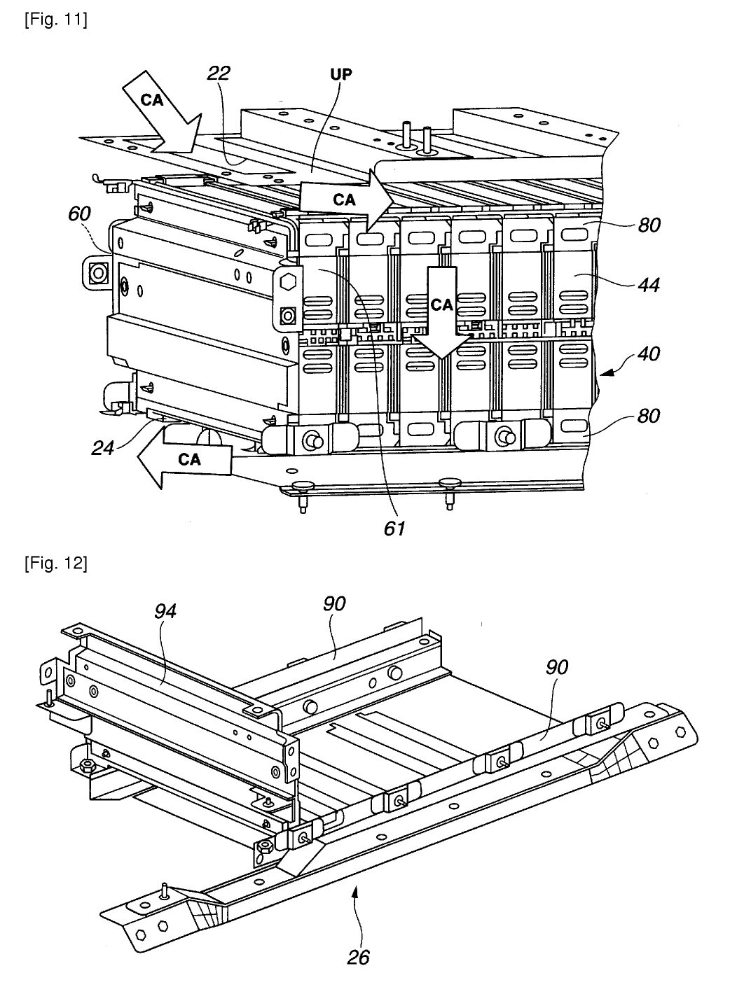

In FIG. 11, there is shown a part of the battery pack 20 with some elements removed for showing a cooling air passage defined in the battery pack 20. As shown, cooling air CA from an air inlet opening 22 is permitted to flow downstream through the fine spaces (or fine passages) between the stacked battery modules 40 and discharged from an air outlet opening 24 to the outside.

The air inlet opening 22 is provided in an upper panel UP mounted on one side of battery stack 30 with a given space defined therebetween, and the air outlet opening 24 is provided below battery stack 30. Due to the flow of such cooling air CA, each battery module 40 is cooled.

Part of the cooling air is permitted flow near output terminals 41 of each battery module 40, which prevents the terminals 41 from collecting dust particles. Since rib portions 70 of couplers 60 and 61 are positioned away from the charging/generating zone 58 of each battery module 40, such rib portions 70 do not obstruct a smoothed flow of the cooling air CA in the cooling air passage, which increases a cooling effect of the air to battery modules 40.

As is seen from FIGS. 10 and 11, when a plurality of coupler-mounted battery modules 40 are properly stacked, the upper and lower corner holding portions 80 of the couplers 60 and 61 of the battery modules 40 are arranged to constitute so-called banks of the upper and lower air flow passages.

In the following, method of producing or assembling the battery pack 20 (see FIG. 1) will be described in detail with the aid of the accompanying drawings, particularly FIGS. 12, 13, 14, 15, 16, 17 and 18.

First, as is seen from FIG. 12, there is prepared a holding structure that comprises a pair of lower stack frames 90 fixed to lower portions of the housing 26 and a front end plate 94 fixed to front ends of the lower stack frames 90.

Then, as is seen from FIG. 13, a first coupler-mounted battery module 40 is put on lower stack frames 90 in a manner to contact with the front end plate 94. As is mentioned hereinabove, the rounded guide portions 86 (see FIGS. 8 and 9) of couplers 60 and 61 are guided by the lower stack frames 90 for smoothly guiding the first coupler-mounted battery module 40 to the correct position.

Then, a second coupler-mounted battery module 40 is put on lower stack frames 90 and moved toward the already set first coupler-mounted battery module 40 sliding the rounded guide portions 86 thereof on the lower stack frames 90.

Upon this, the projected pawls 82 of couplers 60 and 61 of the first coupler-mounted battery module 40 become engaged with the catching recesses 84 of couplers 60 and 61 of the second coupler-mounted battery module 40 thereby to couple the first and second coupler-mounted battery modules 40 tightly, as is understood from FIG. 13. In this condition, rib portions of couplers 60 and 61 of the first coupler-mounted battery module 40 constitute partition means for defining part of the cooling air passage between the rib portions and case 42 of the second coupler-mounted battery module 40.

Under this condition, due to provision of pad portions 88, the connection between each coupler-mounted battery module 40 and lower stack frames 90 is tightly made.

Then, third, fourth, fifth, , , , and twelfth coupler-mounted battery modules 40 are put and moved on lower stack frames 90 one after another in the above-mentioned manner. Of course, due to provision of projected pawls 82 and catching recesses 84 provided by each battery module 40, the twelve coupler-mounted battery modules 40 stacked on lower stack frames 90 become combined tightly. This combined condition is shown in FIG. 15.

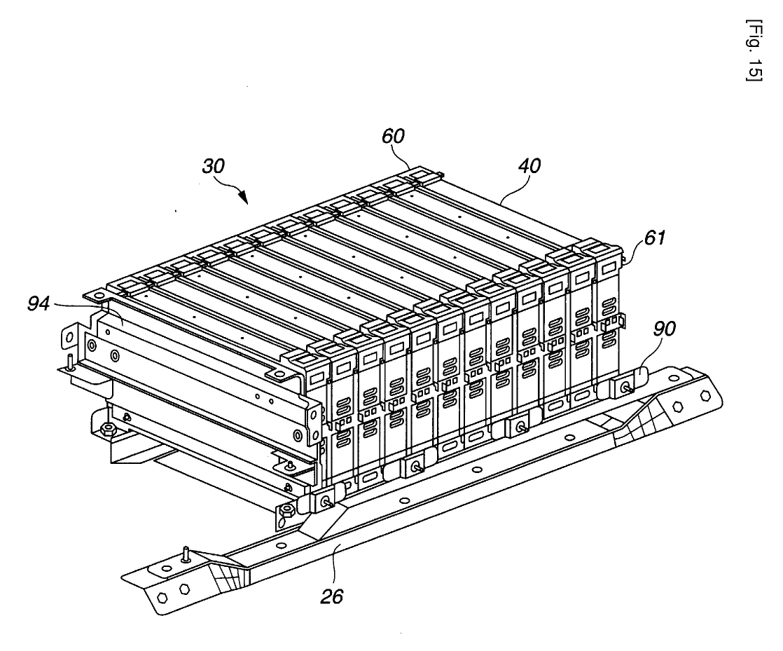

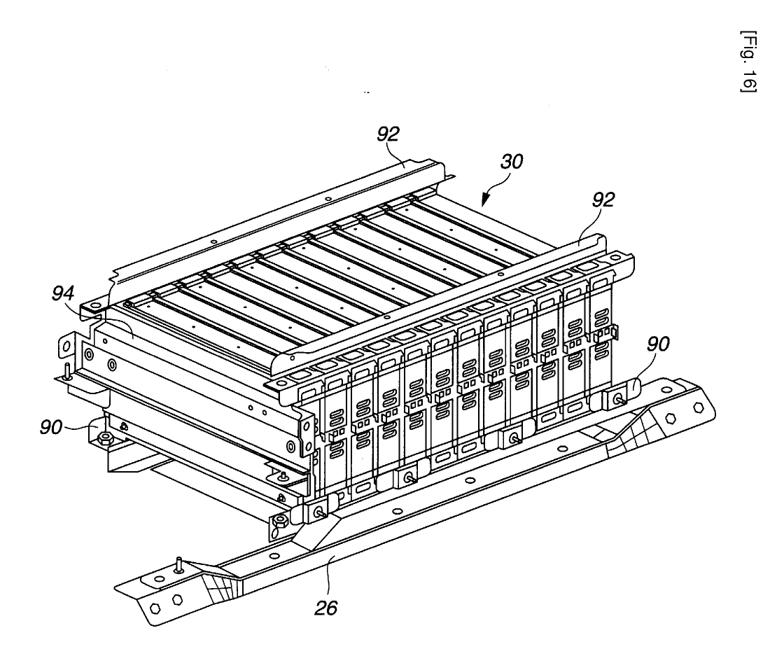

As will be understood from FIGS. 14 and 15, when the twelve coupler-mounted battery modules 40 are properly stacked on lower stack frames 90, the lower corner holding portions 80 of couplers 60 and 61 contact with lower stack frames 90 through pad portions 88. Thus, a side wall for the cooling air passage is constituted by the holding portions 80 and each of lower stack frames 90.

Then, as is seen from FIG. 16, a pair of upper stack frames 92 are put on laterally opposed upper sides of the twelve coupler-mounted battery modules 40 thus stacked.

Upon this, as will be understood from FIG. 9, each upper stack frame 92 contacts the rounded guide portions 86 of the upper corner holding portions 80 of the couplers 60 or 61 of the battery modules 40. That is, each upper stack frame 92 is positioned by such rounded guide portions 86.

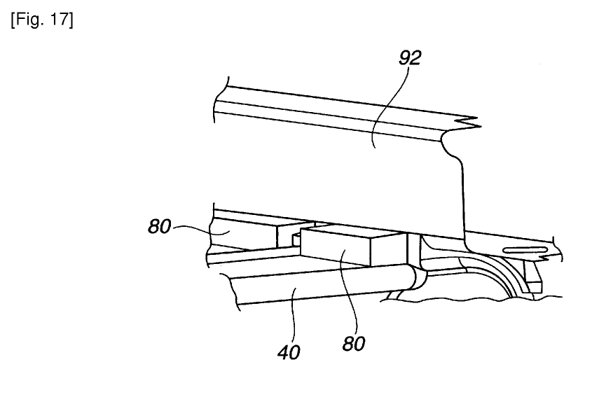

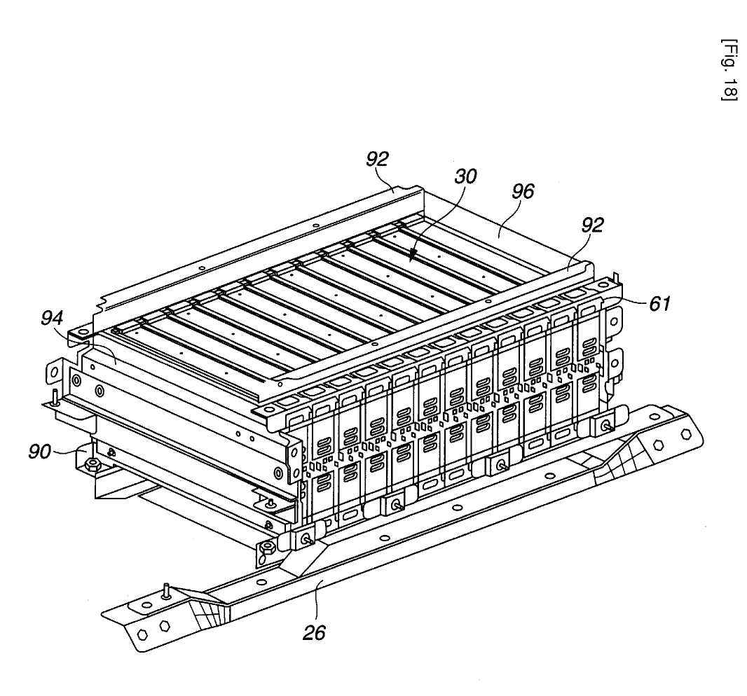

As is seen from FIG. 17, when the two upper stack frames 92 are properly mounted on the combined twelve battery modules 40, upper stack frames 92 contact the upper corner holding portions 80 of couplers 60 and 61 and thus constitute a side wall for the cooling air passage.

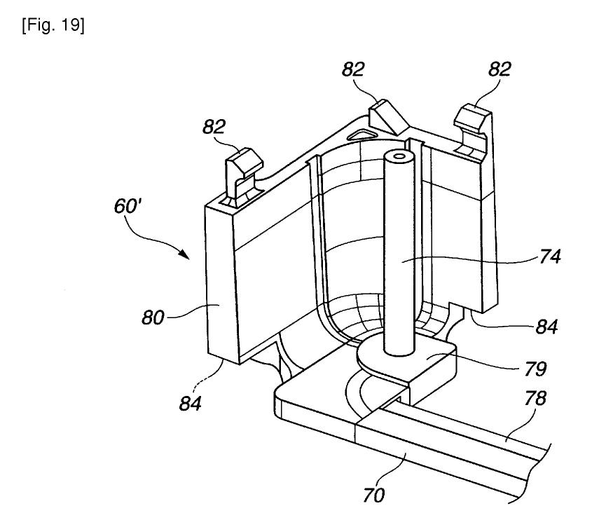

Then, as is seen from FIG. 18, a rear end plate 96 is placed at a rear end of the combined twelve coupler-mounted battery modules 40 and fixed to both rear ends of upper stack frames 92 and those of lower stack frames 90. Then, front ends of upper stack frames 92 are fixed to upper portions of front end plate 94.

Thus, the combined twelve coupler-mounted battery modules 40 are much tightly held by a rectangular frame structure that comprises front end plate 94, lower end plate 96, two lower stack frames 90 and two upper stack frames 94.

It is now to be noted that in the above-mentioned battery module holding structure, so-called through bolts that pass through all of the combined battery modules 40 are not used. Actually, in prior art battery module holding structure, such through bolts are used. As will be easily known, using such through bolts brings about complicated work for combining the battery modules and thus causes increased cost of the battery back.

As will be understood from the above description, when a second coupler-mounted battery module 40 is put beside a first coupler-mounted battery module 40 and pushed toward the first coupler-mounted batter module 40, these two battery modules 40 are combined due to function of the coupling structures possessed by couplers 60 and 61 of these two battery modules 40. Like this, third, fourth, fifth, , , , and last coupler-mounted battery modules 40 can be combined to the already combined battery modules 40. This combining work is very simple and easy.

Due to the unique structure of couplers 60 and 61, when a given number of coupler-mounted battery modules 40 are combined in the above-mentioned manner and put in the housing 26, a desired cooling air passage is automatically formed in the housing 26. The cooling air passage is constructed to direct part of the cooling air against output terminals 41 of each battery module 40 and thus output terminals 41 are prevented from collecting dust particles.

By employing lower stack frames 90, placing the coupler-mounted battery modules 40 to right positions is easily made as is mentioned hereinabove. Actually, in this case, the rounded guide portions 86 possessed by corner holding portions 80 of couplers 60 and 61 smoothly slide on the lower stack frames 90.

Due to provision of pad portions 78, 79 and 88 by couplers 60 and 61 that are made of a shock absorbing material, any shock or vibration inevitably applied to the battery stack 30 from the housing 26 is suitably absorbed or at least attenuated. Furthermore, due to provision of such pad portions 78, 79 and 88, undesired slippage or displacement between two battery modules 40 is suppressed or at least minimized.

Because rib portions 70 of couplers 60 and 61 are positioned away from the charging/generating zone 58 of each battery module 40, such rib portions 70 do not obstruct a smoothed flow of the cooling air CA in the cooling air passage, which increases a cooling effect of the air to the coupler-mounted battery modules 40.

Couplers 60 and 61 used in the present invention are the same in construction. This brings about not only easiness with which the couplers 60 and 61 are fitted to proper places of battery modules 40 but also reduction in production cost of the battery pack 20.

Due to the unique structure of couplers 60 and 61, a certain cooling air passage is automatically defined in the housing 26 of the battery pack 20, as is mentioned hereinabove.

Due to provision of dimples 48 and 49 against which pin portions 72 of couplers 60 and 61 abut, positioning between each coupler 60 or 61 and the battery module 40 is assuredly made.

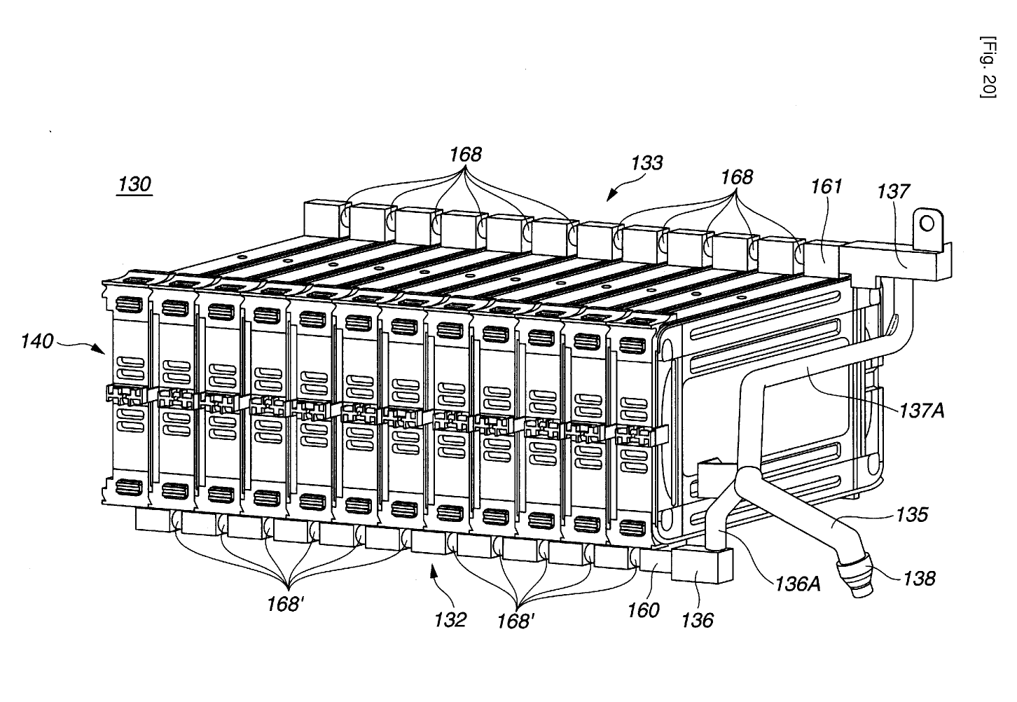

Referring to FIG. 19, there is shown a modified coupler 60′ that is employable as a replacement of the above-mentioned coupler 60. Although not shown in this drawing, when this modified coupler 60′ is used, the other coupler 61 is also replaced with a modified coupler that is the same as the modified coupler 60′.

As is seen from FIG. 19, modified coupler 60′ is substantially the same as the above-mentioned coupler 60 except two pole portions 74 each being integrally formed on corner holding portion 80. More specifically, each pole portion 74 is a replacement of the pin portion 72 (see FIG. 6) possessed by rib portion 70 of the coupler 60.

That is, as will be imaged from FIG. 6, when modified coupler 60′ is practically attached to a battery module 40, the two pole portions 74 possessed by coupler 60′ are inserted into two bores (not shown) formed in the battery module 40. With such pole portions 74, the connection between modified coupler 60′ and battery module 40 is much assured.

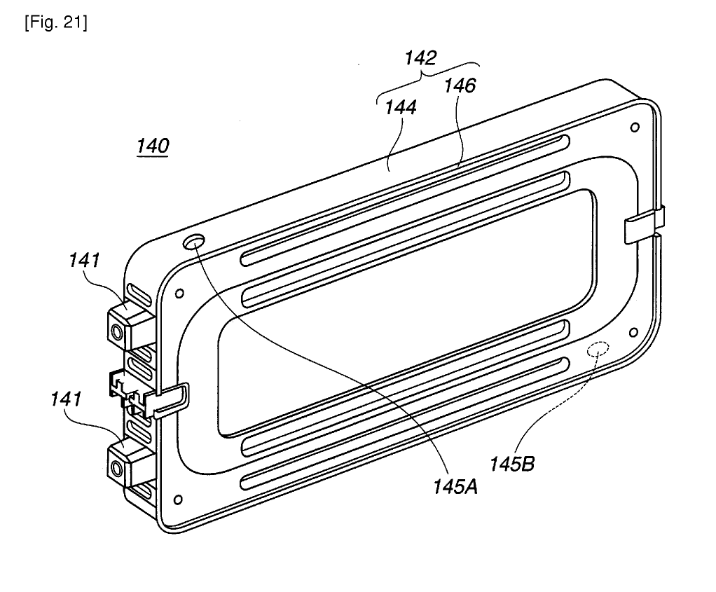

Referring to FIG. 20, there is shown a battery stack 130 for a battery pack of a second embodiment of the present invention.

Since the battery stack 130 is similar in construction to the above-mentioned battery stack 30 (see FIG. 3) of the first embodiment, only portions or portions that are different from those of the battery stack 30 of the first embodiment will be described in detail in the following.

As is seen from FIG. 20, in the second embodiment, battery stack 130 is constructed to have further first and second gas discharging piping units 132 and 133. Each gas discharging piping unit 132 or 133 functions to convey or discharge any gas, which is inevitably produced in battery modules 140, to the outside.

Like battery stack 30 of the first embodiment, battery stack 130 of the second embodiment comprises a plurality (twelve in the illustrated example) of battery modules 140 each having two groups of identical couplers 160 and 161 mounted on axially opposed ends thereof.

Like the above-mentioned couplers 60 and 61 of the first embodiment, these couplers 160 and 161 of the second embodiment have coupling structures through which a plurality of coupler-mounted battery modules 140 are combined or stacked to constitute the battery stack 130 of FIG. 20.

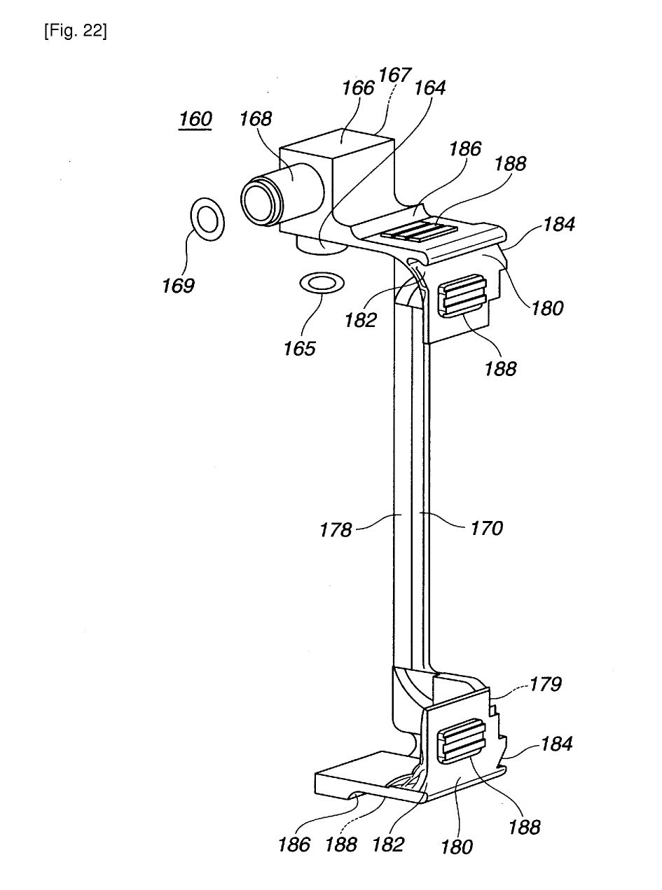

Each coupler 160 or 161 has at one of side wall portions thereof a pipe portion (168 see FIG. 22) which constitutes part of the gas discharging piping unit 132 or 133 respectively.

As is seen from FIG. 21, each battery module 140 comprises a rectangular case 142 that includes a lower case part 144 that is shaped like a rectangular pan and an upper case part 146 that is shaped like a flat rectangular lid.

As is seen from the drawing, lower case part 144 of each battery module 140 is formed at laterally opposed side portions with gas outlet openings 145A and 145B through which any gas produced in battery module 140 is discharged to the above-mentioned second and first gas discharging units 133 and 132.

As shown, each gas outlet opening 145A or 145B is placed near a corner of lower case part 144. More specifically, these two gas outlet openings 145A and 145B are positioned at symmetrical positions with respect to a center of lower case part 144.

Like the battery module 40 of the first embodiment, battery module 140 has two output terminals 141.

As will be seen from FIG. 20, when the coupler-mounted battery modules 140 are properly stacked, pipe portions 168 provided on upper right ends (as viewed in the drawing) are connected to one another to constitute the gas discharging piping unit 133 and at the same time, pipe portions 168′ provided on lower left ends (as viewed in the drawing) are connected to one another to constitute the gad discharging piping unit 132. Actually, a cylindrical bore 167 is placed between the two pipe portions 168 as will become apparent as the description proceeds.

It is to be noted that gas outlet opening 145A (see FIG. 21) of each coupler-mounted battery module 140 is exposed to the interior of the gas discharging piping unit 133, while gas outlet opening 145B of each coupler-mounted battery module 140 is exposed to the interior of the other gas discharging piping unit 132, as will become apparent as the description proceeds.

As is seen from FIG. 20, to one (or right) end of the gas discharging piping unit 132, there is connected a pipe connector 136 from which a shorter pipe 136A extends. Like this, to one (or right) end of the other gas discharging piping unit 133, there is connected another pipe connector 137 from which a longer pipe 137A extends toward the shorter pipe 136A.

Leading ends of the shorter and longer pipes 136A and 137A are connected to a main pipe 135 that has a gas outlet nozzle 138. The nozzle 138 may be constructed of ethylene propylene dien monomer (EPDM) or the like.

Although not shown in FIG. 20, the gas outlet nozzle 138 is exposed to an air outlet opening, such as the air outlet opening 24 (see FIG. 11) of the cooling air passages. Due to flow of the cooling air in the cooling air passage, there is produced a negative pressure area near the gas outlet nozzle 138, which promotes a gas discharging effect of the gas discharging piping units 132 and 133.

In the following, couplers 160 and 161 will be described in detail with reference to FIGS. 22, 23, 24 and 25. Since these couplers 160 and 161 are the same in construction, only coupler 160 will be described for simplification of description.

Referring to FIG. 22, there is shown the coupler 160. Like in the above-mentioned embodiment, the coupler 160 and its partner-coupler 161 are put on axially opposed sides of battery module 140, as may be understood from FIG. 20.

Referring back to FIG. 22, coupler 160 generally comprises a rib portion 170 and two corner holding portions 180 formed on axially opposed ends of rib portion 170.

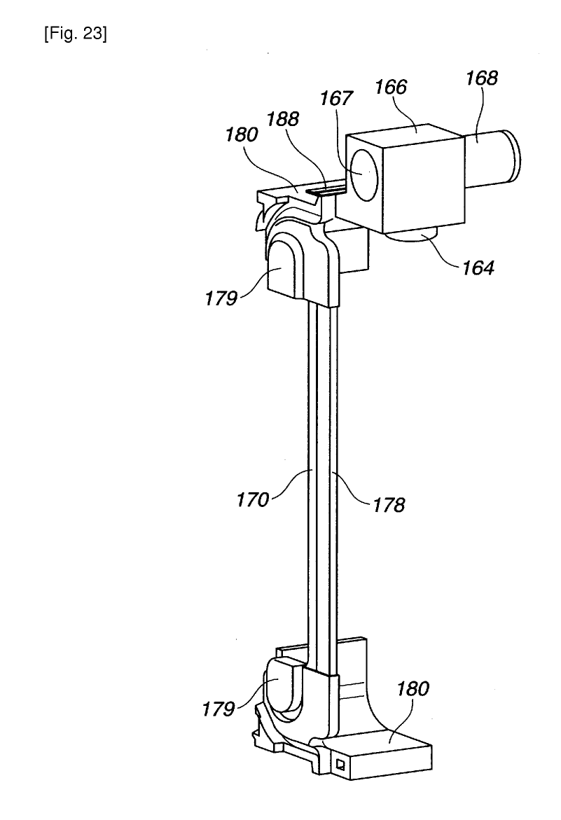

As is seen from FIGS. 22 and 23, like in couplers 60 and 61 of the first embodiment, rib portion 170 comprises two flat semicircular pad portions 179 that are respectively formed at axially opposed portions of rib portion 170 and face one direction, and an elongate pad portion 178 that extends between two flat corner portions on which the flat semicircular pad portions 179 are provided. The elongate pad portion 178 faces the other direction. That is, when properly coupled, the two flat semicircular pad portions 179 faces or contacts upper case part of an adjacent coupler-mounted battery module 140, and the elongate pad portion 178 faces or contacts the bottom of the lower case part of the associated battery module 140.

As is seen from FIG. 22, corner holding portions 180 of coupler 160 are shaped to hold or cover the corner portions of lower case part 144 of the associated battery module 140.

Each corner holding portion 180 is formed with a coupling structure that is constructed to join the battery module 140 to an adjacent battery module 140.

The coupling structure of each corner holding portion 180 generally comprises a projected pawl 182, a catching recess 184, a guide portion 186 and two pad portions 188. As is understood from FIG. 22, projected pawl 182 and catching recess 184 are respectively formed at opposed ends of corner holding portion 180, and guide portion 186 and pad portions 188 are formed on a middle portion of corner holding portion 180.

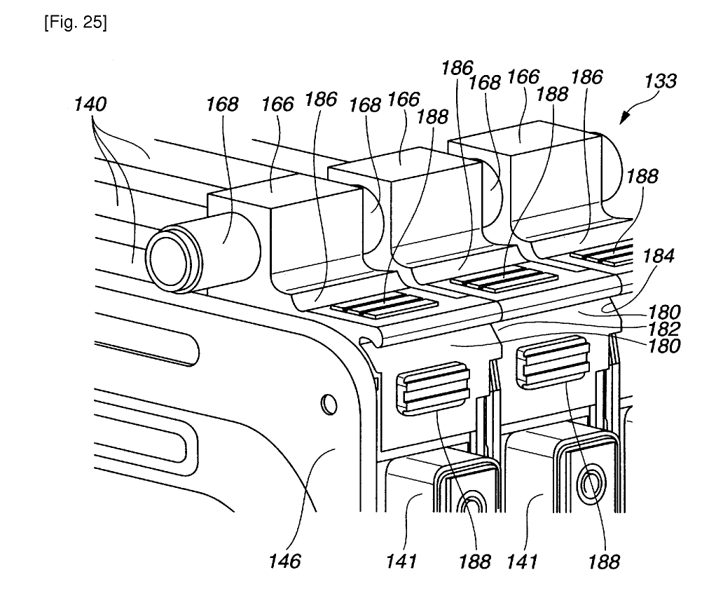

As is seen from FIGS. 22 and 25, when coupler-mounted battery modules 140 are properly stacked, two projected pawls 182 of coupler 160 of one battery module 140 are detachably caught by corresponding two catching recesses 184 of coupler 160 of an adjacent battery module 140.

Guide portion 186 has a rounded outer surface and has the same function as the above-mentioned guide portion 86 of first embodiment and pad portions 188 have the same function as the above-mentioned pad portions 88 of the first embodiment.

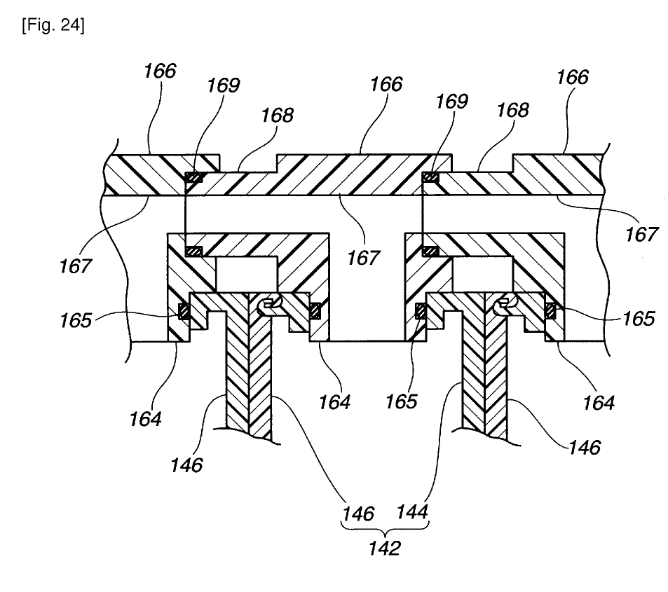

As is seen from FIGS. 22 and 23, one of corner holding portions 180 is formed with a cube portion 166 that is hollow. The cube portion 166 is formed with a lower pipe 164 that is connected through an O-ring 165 to the gas outlet opening 145A (see FIG. 21) of an associated battery module 140. The arrangement of O-ring 165 relative to lower pipe 164 is clearly shown in FIG. 24.

As is shown in FIG. 22, the cube portion 166 is provided at one end thereof with the above-mentioned pipe portion 168, and as is seen from FIG. 23, the cube portion 166 is provided at the other end thereof with a cylindrical bore 167.

The pipe portion 168 and cylindrical bore 167 are coaxially arranged and pipe portion 168 extends in a direction in which a plurality of coupler-mounted battery modules 140 are stacked.

As is seen from FIG. 24, cylindrical bore 167 has a diametrically enlarged mouth portion that is sized to neatly receive therein pipe portion 168 of an adjacent battery module 140.

For achieving a gastight connection between cylindrical bore 167 and pipe portion 168 when coupled, an O-ring 169 is operatively used in such manner as is shown in FIG. 24.

As is seen from FIG. 25, when a plurality of coupler-mounted battery modules 140 are stacked one after another in such a manner as is described in the section of the first embodiment, pipe portions 168 (or 168′) of battery modules 140 are put into cylindrical bores 167 of their adjacent battery modules 140. Thus, the above-mentioned first and second gas discharging piping units 132 and 133 are produced.

The above-mentioned O-rings 165 and 169 are constructed of a rubber material or a mixture of rubber material and plastic material. Preferably, O-rings 165 and 169 are made more flexible than elongate pad portion 178 and flat semicircular pad portions 179 of rib portion 170. With such material selection, the gastight connection between pipe portion 168 (or 168′) and the corresponding cylindrical bore 167, and that between lower pipe 164 and gas outlet opening 145A (or 145B) of battery module 140 are assuredly made.

The entire contents of Japanese Patent Applications 2008-104682 filed Apr. 14, 2008 and 2009-048211 filed Mar. 2, 2009 are incorporated herein by reference.

Although the invention has been described above with reference to the embodiments of the invention, the invention is not limited to such embodiments as described above. Various modifications and variations of such embodiments may be carried out by those skilled in the art, in light of the above description.

1. A battery pack comprising:
a battery stack that includes:
a plurality of battery modules that are arranged in parallel in side-by-side relationship;
a plurality of couplers each being mounted on a given portion of the corresponding battery module thereby to constitute a coupler-mounted battery module, the couplers being detachably connected to one another to constitute an aligned unit of the couplers,
wherein each of the couplers comprises:
a plurality of projected pawls provided by one side of the coupler; and
a plurality of catching recesses provided by the other side of the coupler, and positioned relative to the projected pawls with respect to the direction of an imaginary surface to which mutually facing surfaces of two adjacent battery modules face when the adjacent battery modules are arranged in parallel, the catching recesses catching and coupling with the projected pawls of an adjacent coupler for constituting part of the aligned unit of the couplers.

2. A battery pack as claimed in claim 1, in which the couplers are the same in construction.

3. A battery pack as claimed in claim 1, in which the coupler further comprises:
a rib portion that is put on one major surface of the corresponding battery module; and
two corner holding portions that are formed on an axially opposed ends of the rib portion to hold paired corner portions of the battery module, the two corner holding portions having the projected pawls and the catching recesses.

4. A battery pack as claimed in claim 3, in which the rib portion of the coupler has a given thickness so that when mutually adjacent two coupler-mounted battery modules are coupled, a given clearance is defined between the two coupler-mounted battery modules.

5. A battery pack as claimed in claim as claimed in claim 3, in which the coupler further comprises pad portions that are resiliently pressed against the other surface of the other adjacent battery module.

6. A battery pack as claimed in claim 3, in which the coupler further comprises a rounded guide portion that is slidably engaged with a guide member of a housing for smoothly moving the coupler to a desired position.

7. A battery pack as claimed in claim 3, in which the coupler further comprises pin portions possessed by axially opposed ends of the rib portion, the pin portions being pressed into dimples formed on corner portions of the major surface of the corresponding battery module thereby to achieve a positioning of the coupler relative to the battery module.

8. A battery pack as claimed in claim 3, in which the coupler further comprises pole portions possessed by axially opposed ends of the rib portion, the pole portions being inserted into bores formed in corner portions of the corresponding battery module thereby to achieve a mutual connection between the coupler and the battery module.

9. A battery pack as claimed in claim 1, further comprising a housing that covers the battery stack leaving a given space therebetween.

10. A battery pack as claimed in claim 9, in which the given space comprises:
an upper space part that is defined between a ceiling of the housing and an upper part of the battery stack;
a plurality of fine spaces each being defined between mutually adjacent two coupler-mounted battery modules; and
a lower space part that is defined between a bottom of the housing and a lower part of the battery stack,
wherein the upper space part has an air inlet opening through which cooling air is led into the upper space part and the lower space part has an air outlet opening from which the cooling air having passed through the fine spaces is discharged to the outside of the housing.

11. A battery pack as claimed in claim 9, further comprising:
a pair of lower stack frames by which lower side ends of the battery stack are held;
a pair of upper stack frames by which upper side ends of the battery stack are held;
a front end plate by which the frontmost one of the coupler-mounted battery modules is held; and
a rear end plate by which the rearmost one of the battery modules is held.

12. A battery pack as claimed in claim 1, further comprising:
a gas discharging structure that discharges gas, which is produced in the battery modules, into the outside.

13. A battery pack as claimed in claim 12, in which the gas discharging structure comprises:
a gas discharging piping unit that is formed on one side of the battery pack and communicated with an interior of each battery module through a first gas outlet opening formed in each battery module; and
a main pipe that has an inlet tube portion connected to the gas discharging piping unit and a gas outlet nozzle that is adapted to be placed at a position where a negative pressure is produced due to flow of the cooling air.

14. A battery pack as claimed in claim 13, in which the gas discharging piping unit comprises:
pipe portions respectively provided by the couplers, each pipe portion being communicated with the interior of the corresponding battery module; and
cylinder bores respectively provided by the couplers,
wherein the pipe portion of the couplers are respectively connected to the cylinder bores of the adjacent couplers.

15. A battery pack as claimed in claim 3, in which the coupler further comprises:
a tubular portion, the tubular portion having a pipe portion that is mated with a gas outlet opening formed in the battery module when the coupler is properly mounted on the battery module; and
a cylindrical bore that is constructed to receive the tubular portion of the coupler of an adjacent coupler-mounted battery module.

16. A battery pack as claimed in claim 15, further comprising a plurality of O-rings through which the connection between the pipe portion and the gas outlet opening and the connection between the cylindrical bore and the tubular portion are hermetically achieved.

17. A battery pack comprising:
a battery stack that includes:
a plurality of battery modules that are arranged in parallel in side-by-side relationship;
a first group of couplers each being mounted on a first given portion of the corresponding battery module, the first group of couplers being detachably connected to one another to constitute a first aligned unit of the first group of couplers; and
a second group of couplers each being mounted on a second given portion of the corresponding battery module, the second group of couplers being detachably connected to one another to constitute a second aligned unit of the second group of couplers,
wherein each of the couplers of the first and second groups comprises:
a plurality of projected pawls provided by one side of the coupler; and
a plurality of catching recesses provided by the other side of the coupler and positioned relative to the projected pawls with respect to the direction of an imaginary surface to which mutually facing surfaces of two adjacent battery modules face when the adjacent battery modules are arranged in parallel, the catching recesses catching and coupling with the projected pawls of an adjacent coupler for producing part of the first or second aligned unit.

18. A method of producing a battery pack comprising a battery stack that a includes plurality of battery modules that are arranged in parallel in side-by-side relationship; a plurality of couplers each being mounted on a given portion of the corresponding battery module thereby to constitute a coupler-mounted battery module, the couplers being detachably connected to one another to constitute an aligned unit of the couplers, wherein each of the couplers comprises a plurality of projected pawls provided by one side of the coupler; and a plurality of catching recesses provided by the other side of the coupler and positioned relative to the projected pawls with respect to the direction of an imaginary surface to which mutually facing surfaces of two adjacent battery modules face when the adjacent battery modules are arranged in parallel, the catching recesses catching and coupling with the projected pawls of an adjacent coupler for constituting part of the aligned unit of the couplers,
the method comprising in steps:
(a) preparing a plurality of coupler-mounted battery modules each including a battery module and a coupler mounted on a given portion of the battery module;
(b) putting a first one of the coupler-mounted battery modules at a first given position;
(c) putting a second one of the coupler-mounted battery modules at a position beside the first one of the coupler-mounted battery modules;
(d) pressing the second one of the coupler-mounted battery modules against the first one of the coupler-mounted battery module to achieve a connection between the projected pawls of the second one of the coupler-mounted battery modules and the catching recesses of the first one of the coupler-mounted battery modules; and
(e) repeating the same operation as the steps (b), (c) and (d) one after another on the remaining coupler-mounted battery modules.

19. A method as claimed in claim 18, further comprising, before the step (b), (f) preparing a pair of elongate guide members so that the steps (b), (c) and (d) are carried out by smoothly sliding the first and second ones of the coupler-mounted battery modules on and along the pair of elongate guide members.

20. A method as claimed in claim 19, further comprising, before the step (b) (g) setting a front end plate at a given position so that the first one of the coupler-mounted battery module is pressed against the front end plate to assuredly take the first given position; and
after the step (e), (h) setting a rear end plate at a given position so that the last set coupler-mounted battery module is held by the rear end plate.

21. A motor vehicle comprising:
a prime mover that drives road wheels by consuming electric energy; and
a battery pack that feeds the prime mover with the electric energy, the battery back comprising a battery stack that includes a plurality of battery modules that are arranged in parallel in side-by-side relationship; a plurality of couplers each being mounted on a given portion of the corresponding battery module thereby to constitute a coupler-mounted battery module, the couplers being detachably connected to one another to constitute an aligned unit of the couplers, each of the couplers comprising a plurality of projected pawls provided by one side of the coupler; and a plurality of catching recesses provided by the other side of the coupler and positioned relative to the projected pawls with respect to the direction of an imaginary surface to which mutually facing surfaces of two adjacent battery modules face when the adjacent battery modules are arranged in parallel, the catching recesses catching and coupling with the projected pawls of an adjacent coupler for constituting part of the aligned unit of the couplers.
